(19) United States
(12) Patent Application Publication
(10) Pub. No.: US 2017/0232461 A1
(43) Pub. Date: Aug. 17, 2017

(54) DUST AND GAS EJECTION VALVE

(71) Applicant: "LASCOM" LIMITED LIABILITY COMPANY, Dubna (RU)

(72) Inventors: Valentin Sergeevich Chadin, Obukhovo (RU); Timur Alekperovich Aliev, Bezdedovo (RU); Alekper Kamalovich Aliev, Bezdedovo (RU); Artem Vasilievich Motuzyuk, Dubna (RU)

(21) Appl. No.: 15/514,674

(22) PCT Filed: Aug. 21, 2015
(86) PCT No.: PCT/RU2015/000531

§ 371 Date: Mar. 27, 2017

(30) Foreign Application Priority Data
Sep. 25, 2014 (RU) 2014138801

(51) Int. Cl. B05B 15/04; B05B 7/16; B24C 9/00; B05B 7/14

(52) U.S. Cl. CPC B05B 15/0412; B05B 7/1486; B05B 7/1626; B05B 15/0425; B05B 15/0431; B24C 9/003

(57) ABSTRACT

The invention relates to removal from the working area of a dust and gas mixture produced by action of a processing tool on the material being processed. The present dust and gas valve is intended to be mounted in an apparatus for processing materials. The dust and gas valve comprises a casing adapted to accommodate a processing tool and to be connected to a system for aspirating the produced dust and gas mixture, and means for directing the dust and gas mixture into the casing. According to the invention said means comprises: a unit for directional supply of compressed air to the working area, and a dust and gas mixture flow guiding element having a lower surface disposed around the working area and streamlined for the dust and gas mixture flow.

### TECHNICAL FIELD

The invention relates to removal from the working area of a dust and gas mixture produced by action of a processing tool on the material being processed. It is particularly applicable at deposition of electrically conductive bus bars in the manufacture of electrically heated glass for aviation, railway, shipbuilding, armored transport and automotive industry, and can be also used in other spheres where it is required to remove dust or dust and gas mixture from the working area of various materials.

### BACKGROUND OF THE INVENTION

A variety of aspiration systems are known and used in industrial production for various technological processes, in which a valve connected to a dust and gas mixture aspiration system is mounted in an apparatus for processing materials such that to cover the processing tool of the apparatus.

An example of such a valve is the technical solution disclosed in DE 3800050 A1, in which the valve is made in the shape of a hood that is mounted on the spindle of a cutting tool and comprises a system for supplying compressed air to a working area and a channel for directing dust and gas mixture to a suction system. However, in this apparatus the system for supplying compressed air to the working area serves only to create an air curtain that prevents release of the dust and gas mixture beyond the working area and, thus, is not an ejecting means.

A variety of devices are also known, in which a dust and gas valve is used in laser processing of materials. An example of such a device is a dust and gas valve disclosed in U.S. Pat. No. 4,942,284. In this device a casing, called “ejector”, is mounted on a laser nozzle and connected to a system for suction of the produced dust and gas mixture. The casing further comprises a unit for directional supply of compressed air at an acute angle to a working area from the side of a peripheral region of the working area. Compressed air is injected through a plurality of openings arranged in a circle. Furthermore, as noted, the inclined arrangement of compressed gas flows creates a vacuum under the lower periphery of the ejector, thereby organizing circulations of air flowing from the outside towards the ejector and beneath the ejector.

However, none of the prior art apparatuses solves the problem of processing materials in their distal regions, i.e. none of these apparatuses can exclude passage of the dust and gas mixture between the valve casing and the space beyond edges of the material.

### DISCLOSURE OF THE INVENTION

Therefore, the main object of the present invention is to provide a dust and gas ejection valve, which enables removal of the dust and gas mixture in operation both at the edge and in the center of the surface.

Another object is to provide a dust and gas valve, which when mounted in an apparatus for gas-dynamic spraying could employ the supersonic jet of the apparatus as an auxiliary means for ejecting process products that require aspiration.

The above objects are accomplished in a dust and gas valve according to the invention, mountable in an apparatus for processing materials, comprising:

a casing adapted to accommodate a processing tool and to be connected to a system for aspirating the produced dust and gas mixture; and means for directing the dust and gas mixture into the casing, including:

a unit for directional supply of compressed air to a working area from the side of a peripheral region of the working area; and

a dust and gas mixture flow guiding element having a lower surface disposed around the working area and streamlined for the dust and gas mixture flow.

Preferred embodiments provide for the following additional distinctive features of the inventive valve.

The lower surface of the dust and gas mixture flow guiding element preferably has an airfoil profile, the front point of which is directed to the working area, and the chord of which is directed at a predetermined angle to the working area.

The dust and gas mixture flow guiding element is preferably coaxial with the processing tool and is suspended on springs with the ability of self-positioning at a predetermined distance from the surface being processed due to the lifting force arising therein at interaction of the dust and gas mixture flow with the airfoil profile.

In an embodiment, the dust and gas mixture flow guiding element may be in the shape of an aerofoil wing, in which both the upper and lower surfaces have an airfoil profile.

The dust and gas mixture flow guiding element can be also mounted with the ability of adjusting the height.

The dust and gas valve may further comprise a confuser disposed within the casing above a mixing chamber formed in the lower part of the casing.

The dust and gas mixture flow guiding element is preferably annular.

The casing preferably comprises at least two parts: a main part and an auxiliary part mounted outside on the main part, which are arranged with the ability of adjusting the position of the main part.

The unit for directional supply of compressed air into the working area from the side of a peripheral region of the working area may comprise an annular nozzle or a plurality of peripheral nozzles formed between the main part and the auxiliary part of the casing.

The annular nozzle or the plurality of peripheral nozzles preferably has a variable cross-section.

The auxiliary part of the casing preferably comprises an external aspiration jacket, and a channel is preferably defined between the aspiration jacket and the main body for supplying compressed air into the space defined between the outer surface of the confuser and the inner surface of the casing.

The confuser is preferably a Laval nozzle and may be formed as separate part secured inside of the casing with the ability of adjusting its position, or may be integrally formed with the dust and gas mixture flow guiding element.

The dust and gas valve according to the invention offers the following technical advantages.

A dust and gas valve is provided, in which different ejecting flows can be alternately priority or alternately main at different stages of processing a material (in operation both at the edge of a surface or in the center of a surface).

A dust and gas valve is provided, which ensures the combination of work of the ejected flows and an element having a streamlined surface and mounted, depending on the ejected product type, in a particular place of the valve.

A dust and gas valve is provided, which is used in a gas-dynamic spraying apparatus, where a supersonic jet, while fulfilling its basic process designation, is simultaneously ejecting for the process products requiring aspiration.

A gas-dynamic valve according to the invention is designed to operate as a part of systems requiring aspiration of dust and gas mixtures produced by the process. It can be also employed in processes of gas-dynamic spraying of fine powders onto various flat and curved surfaces of various materials, in particular, onto a low-emissivity surface of electrically heated glass in the process of depositing conductive bus bars. The valve provides aspiration of fine dust cloud of the powder non adherent to the surface (its share in the technological process can reach up to 70% of the total weight of the powder used), thereby providing the possibility of implementing the process of spraying in industrial premises without the use of special rooms and aspirating chambers. The invention is also applicable in all processes that employ supersonic and subsonic flows discharged from nozzles, used as ejecting and involved in the process of aspiration of suspended gaseous combustion products produced in the technological processes. For example, in a process of cutting polyvinyl butyral interlayer films by laser beam when cutting out and manufacturing triplexes, where the focused laser beam evaporates the film material, and compressed air fed through a Laval nozzle coaxially with the beam not only performs functions of protection of the optics and blows through the cutting channel, but also participates as an ejecting flow for aspirating gaseous products of decomposition of the film.

Term “ejection” used in this application refers to “process of mixing two different fluids (steam and water, water and sand, etc.), where one fluid kept under pressure acts on the other fluid and, entraining it, pushes the fluid to the desired direction” (Dictionary of Foreign Words, M., 2008).

The principle of ejection resides in that a jet of injecting gas, exiting from a nozzle at a high velocity, creates a vacuum and carries the ejected gas away from the surrounding space.

Furthermore, the concept of “streamlined surface” used in this application refers to a surface having a streamlined shape, which according to the Explanatory Naval Dictionary, 2010, is “the outline of outer surfaces of a solid body, which provides nonstall enveloping of the body by incident flow of water, gas (air). Bodies having a streamlined shape exert minimal resistance to movement of the body”.

According to the Dictionary “airfoil surface” is a “surface of an aircraft (wing, empennage, rudder, etc.), at interaction of which with air in motion there arise forces that lift the apparatus and direct its flight”.

The application also uses the “Coanda effect” concept, which according to the Great Encyclopedic Dictionary, Moscow, 1998, represents a hydro-aerodynamic effect, which gives rise to the effect of separation and adhesion of a jet enveloping a solid body.

### BRIEF DESCRIPTION OF THE DRAWINGS

Hereinafter the invention will be explained in more detail by describing specific embodiments in conjunction with the accompanying drawings, where:

FIG. 1 is a schematic view of a dust and gas valve in accordance with the invention.

FIG. 2 is a schematic view of an apparatus for gas-dynamic spraying, in which a dust and gas valve in accordance with the invention can be used.

FIG. 3 is a schematic view showing an embodiment of a dust and gas mixture flow guiding element, which is freely suspended on springs.

FIGS. 4-6 are diagrams showing direction and interaction of gas and dust and gas mixture flows in operation of a dust and gas valve according to the invention.

### DETAILED DESCRIPTION OF THE INVENTION

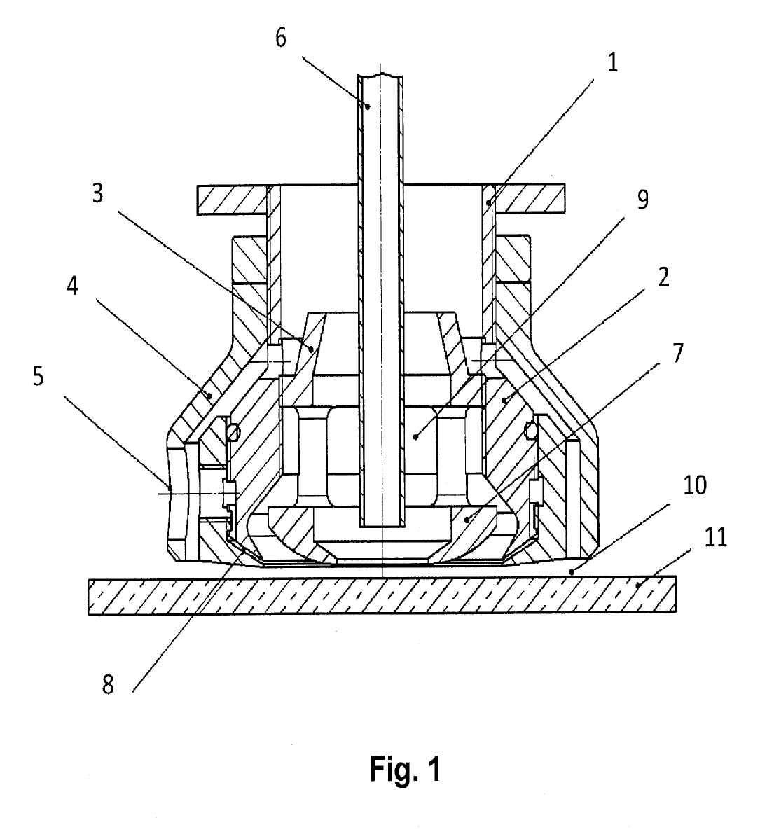

FIG. 1 shows a dust and gas valve according to the present invention as one example of its implementation. The dust and gas valve is preferably mounted coaxially with a processing tool, for example, a supersonic gas-dynamic nozzle of a gas-dynamic spraying system, which supplies an air mixture of fine powder of various compositions. The valve comprises a valve casing 1, in one embodiment consisting of two parts: a main (movable) part 2 and a stationary part 4 (external aspiration jacket).

The casing 1 is adapted to be attached to an apparatus for processing materials such that to cover the processing tool of the apparatus, disposed within the internal passage of the casing (in this case FIG. 1 depicts this tool as a variable cross section output nozzle of a gas-dynamic spraying system). Here, the valve casing can be connected to an aspiration system for aspirating the dust and gas mixture produced by the processing (the system will be explained below). A confuser 3 can be provided in the casing 1 at the end of the mixing chamber 9 (for example, in the form of a Laval nozzle) to increase the velocity of the aspirated flow from the mixing chamber 9 of the casing at inlet to piping of the aspiration system.

The dust and gas valve further comprises means for directing the dust and gas mixture into the casing 1, which includes: a unit of directional supply of compressed air to the working area from the side of a peripheral region of the working area; and an element 7 for guiding the dust and gas mixture flow, having a lower surface disposed around the working area and streamlined for the dust and gas mixture flow.

The unit for directional supply of compressed air to the working area includes an opening 5 connectable to a compressed air source, into which compressed air is supplied in one example under a pressure of 5-6 atmospheres, and further includes a variable cross section nozzle 8 directed at an acute angle to the working area, through which the compressed air is directed to the working area. The variable cross section nozzle 8 may be an annular nozzle or a plurality of nozzles provided in the casing 1 such that they are spaced evenly around the perimeter with the ability of supplying compressed air from a peripheral region of the working area. The compressed air supplied from the nozzle/nozzles 8 is ejecting for air entering through a gap 10 between the glass surface and the lower edge of the valve casing.

The dust and gas mixture flow guiding element 7 may also have different embodiments provided that is ensures guiding the dust and gas mixture from the working area to the casing 1, more specifically, to the mixing chamber 9 of the casing. Engineering solutions implemented in the present device are based on physical laws of aerodynamics and gas outflow, in particular, the Bernoulli law and the Coanda effect. For example, the provision of a streamlined shape in the lower surface of this element provides not only the unobstructed guidance of the dust and gas mixture flow, but also its deviation and adhesion to the surface of the element 7 due to the Coanda effect. In addition, the dust and gas mixture flow directed along the streamlined surface of the element 7 is ejecting for the surrounding air outside of the sheet material edge. Therefore, by using the element 7 with streamlined lower surface, dust and gas removal is effected through a two-stage ejection scheme. In addition, when processing is effected at the edge of the sheet material, where the nozzle 8 cannot ensure directing of the dust and gas mixture, the latter is still prevented from escaping into the surrounding space.

In the embodiment shown in FIG. 1 the dust and gas mixture flow guiding element 7 is formed integrally with a confuser 3, which is mounted in the inner passage of the casing 1 by a threaded connection. Between the external aspiration jacket 4 and the main part 2 of the casing an additional channel may be formed to supply compressed air into the space defined between the outer tapering surface of the confuser, facing away from the working area, and the inner surface of the main part of the casing.

Preferably, the lower streamlined surface of the dust and gas mixture flow guiding element 7 has an airfoil profile, the front point of which is directed to the working area, and the chord of which is directed at an angle to the working area. The height of positioning the lower streamlined surface above the treated surface is selected such that the dust and gas mixture flow originating from the working area could flow around the lower surface and adhere to the lower surface of the element 7 due to the Coanda effect.

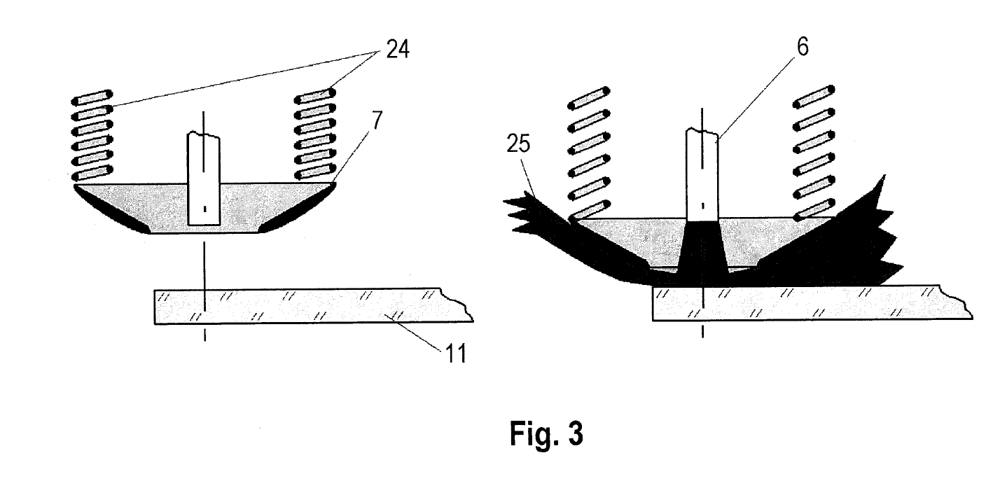

In one embodiment, the dust and gas mixture guiding element 7 can be preferably suspended on springs 24 (see FIG. 3) with the ability of self-positioning at a predetermined distance from the treated surface owing to the lifting force arising in the airfoil profile at interaction with the dust and gas mixture flow 25. In one embodiment, the element 7 may have the shape of an annular airfoil wing having both surfaces with an airfoil profile. In this case, the angle of inclination of the center line of the profile to the processed surface or to the horizontal may range from about 6° to 60°, for example, 20°, and the length of the profile in the horizontal projection may be about 13.5 mm with the diameter of the internal passage of the dust and gas valve of 44 mm.

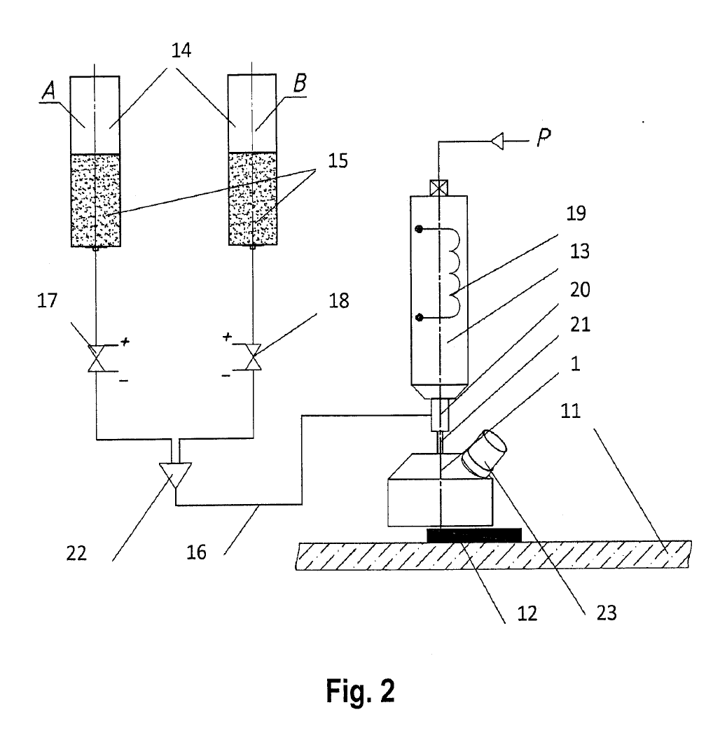

FIG. 2 shows schematically an example of an apparatus for gas-dynamic spraying, which enables depositing electrically conductive bus bars 12 at a desired location on the surface of a low-emissivity glass 11, and which preferably assumes the use of the inventive dust and gas valve. The apparatus comprises a sprayer 13, two feeders 14 (A, B) with powders 15, connected to the sprayer 13 via feed pipes 16 on which pneumatic valves 17, 18 are mounted. The sprayer 13 comprises an air heater 19, a Laval nozzle 20 and an outlet variable cross-section nozzle 21, which is preferably arranged at a height of 10-18 mm above the processed surface. Each of the feeders 14 is alternately connected with the aid of a tee 22 via pipes 16 to the outlet nozzle 21.

The dust and gas valve 8 is mounted on the outlet nozzle 21 and positioned above the working area or, as in this case, above the region of deposition of conductive bus bars 12 onto the surface of a low emissivity glass 11, preferably at a height of 1.0-1.5 mm above the surface, and is connected to a hose 23 of the aspiration system.

It should be noted that, when the dust and gas valve according to the invention is used in a gas-dynamic spraying apparatus the ejecting jet is the jet of sprayed powder as such. Furthermore, the sonic (or supersonic) jet of gas or particulate gas flow emerging along the axis of the valve, in addition to the performed process functions (spraying the powder, blowing-off the cut channel), is in turn ejecting for removal (aspiration) of products of combustion of non adherent fine powder from the working area into the central aspiration system at interaction with the gas-dynamic wing which is specifically positioned relative to the spreading angle (R) of the reflected jet. It is also provided that the wing position can be adjusted in relation to each particular reflected flow.

As an example the operation of the dust and gas valve will be described in the “DIMET” gas-dynamic spraying system (Model 423) supplied by the Obninsk Powder Spraying Center.

Compressed air under the pressure of 6 atmospheres is supplied through an opening 5, and is directed through a variable cross-section nozzle 8 to the working area and from there it enters a mixing chamber 9. As noted above, the compressed air is ejecting for the air flowing through a gap 10 between the glass surface and the lower edge of the valve casing.

Moreover, sections of ejecting and ejected air are chosen to ensure the maximum coefficient of ejection and thereby to provide a great flow rate of air aspirated from the working area and maximally reduce the concentration of harmful substances. The nozzle 8 is designed with a variable cross-section. In this case, it is “sonic”, so air exits from it at a velocity less than the velocity of sound. The choice of the section of the nozzle is dictated by the fact that the valve has limited dimensions, and, for a more complete and effective mixing of the ejecting and ejected air and the dust and gas mixture, boundaries of the ejecting flow must be more “blurred” within the valve, which ensures better mixing with the ejected flows and increases the coefficient of ejection.

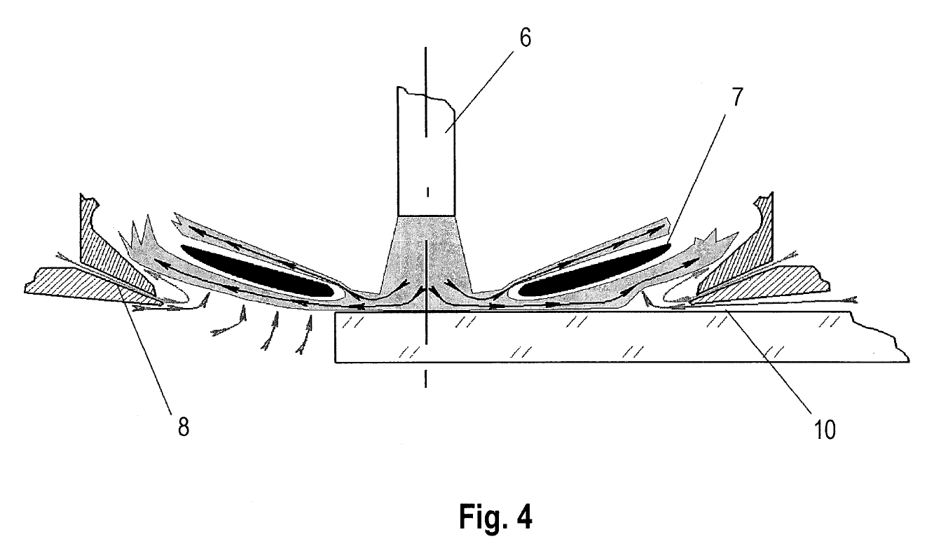

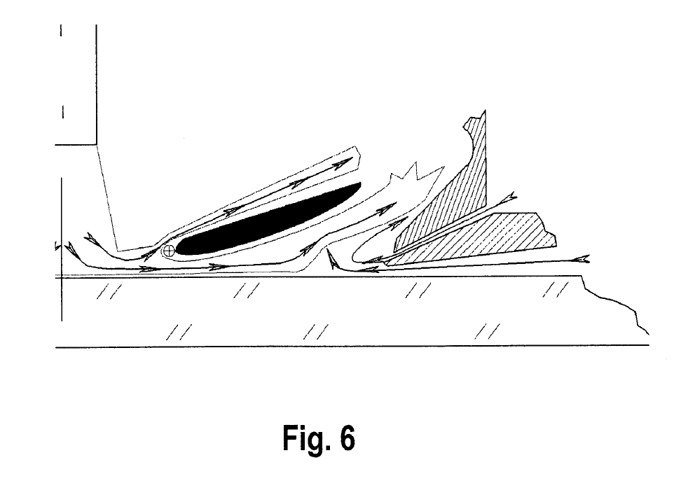

Through the supersonic nozzle 6 (see FIG. 1) the dust and air mixture of fine powder heated to 300° C. is discharged from the nozzle and impinges upon the surface of the glass, while only about 30% of the mixture is secured on the surface. The rest of the dust and gas mixture at angle (R) of spreading particles, flowing around the airfoil wing 7 (“adhering to the wing”) according to the Coanda effect (FIG. 4), enters the mixing chamber 9. Moreover, its additional pressure against the wing, especially when the valve section is partially (up to 50%) above the edge of the glass, is provided by the ejecting jet emerging through the nozzle 8 and the ejected air flowing through the gap 10. High pressure area created at the end of the wing provides a “locking effect” for the powder that has lost energy and is moving near the surface of the glass (FIGS. 4-6).

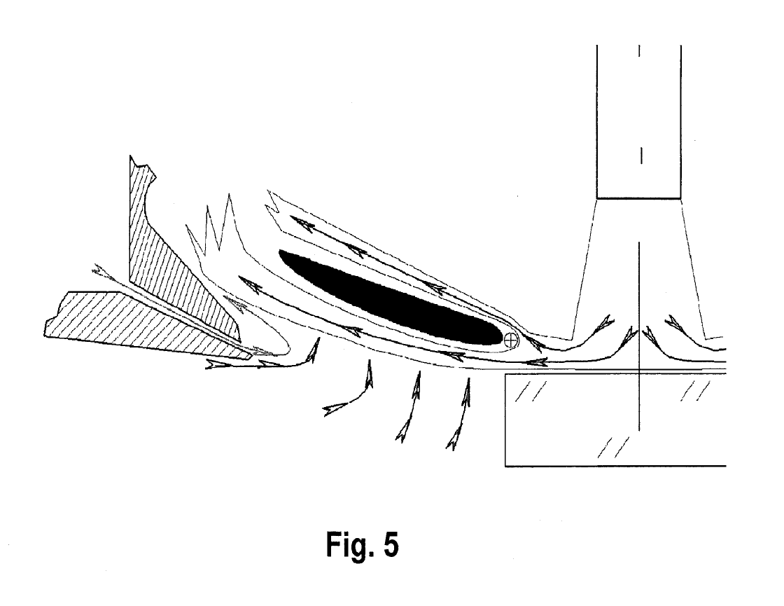

Furthermore, in the present invention the ejecting nozzle 8 provides most effectively separation of the dust and gas mixture far from the edge of the glass (when 100% of the cross section of the valve is disposed above the plane of the processed surface), when the flow rate of the ejected air is limited and when the ejection capability of the supersonic jet of the nozzle 6 is insufficient due to the existing ratio of cross sections of the ejecting flow through the supersonic nozzle 6 and the ejected air through the gap 10 (FIG. 1, 6), since in operation of the “DIMET” system the distance between the lower edge of the supersonic nozzle and the surface of the glass should be in the range of 10-15 mm. At the same time when the valve section is at the edge of the glass (when it is not fully disposed above the surface) the main ejecting jet providing effective separation is the jet reflected under the effect of the supersonic nozzle (see FIGS. 4, 5), flowing around the gas-dynamic wing according to the Coanda effect and additionally pushed down against the wing by atmospheric pressure.

The mixing chamber 9 (FIG. 1) is preferably designed such that the relation of the section of the ejecting supersonic nozzle 6 to its cross section (coefficient of ejection a=F1/F2) provides the maximum volume of ejected air (gas, dust suspension, etc). The confuser 3 (FIG. 1) may have a cross-section of inlet and outlet sections, Fᵢₙ/Fₒᵤₜ, to increase the velocity of the aspirated flow at inlet of the hose 23 of the aspiration system and thereby to ensure the process of ejection through an external aspiration jacket 4 creating one more auxiliary aspiration circuit.

As will be understood by specialists in the art based on the described invention, many changes and modifications may be made in the above-described and other embodiments of the present invention, which are within the scope defined in the appended claims.

Therefore, the detailed description of a preferred embodiment should be taken as illustrative and not restrictive.

1. A dust and gas valve mountable in an apparatus for processing materials, comprising:
a casing adapted to accommodate a processing tool and to be connected to a system for aspirating the produced dust and gas mixture; and
means for directing the dust and gas mixture into the casing, including:
a unit for directional supply of compressed air to a working area from the side of a peripheral region of the working area; and
a dust and gas mixture flow guiding element having a lower surface disposed around the working area and streamlined for the dust and gas mixture flow.

2. A valve according to claim 1, wherein the lower surface of the dust and gas mixture flow guiding element has an airfoil profile, the front point of which is directed to the working area, and the chord of which is directed at a predetermined angle to the working area.

3. A valve according to claim 2, wherein the dust and gas mixture flow guiding element is disposed coaxially to the processing tool and is suspended on springs with the ability of self-positioning at a predetermined distance from the surface being processed due to the lifting force arising therein at interaction of the dust and gas mixture flow with the airfoil profile.

4. A valve according to claim 3, wherein the dust and gas mixture flow guiding element is made in the shape of an aerofoil wing, in which both the upper and lower surface has an airfoil profile.

5. A valve according to claim 1, wherein the dust and gas mixture flow guiding element is mounted with the ability of adjusting the height.

6. A valve according to claim 1 or 5, further comprising a confuser disposed within the casing above a mixing chamber formed in the lower part of the casing.

7. A valve according to anyone of claims 1 to 5, wherein the dust and gas mixture flow guiding element is annular.

8. A valve according to claim 1, wherein the casing comprises at least two parts: a main part and an auxiliary part mounted outside on the main part, which are arranged with the ability of adjusting the position of the main part.

9. A valve according to claim 8, wherein the unit for directional supply of compressed air into the working area from the side of a peripheral region of the working area comprises an annular nozzle or a plurality of peripheral nozzles formed between the main part and the auxiliary part of the casing.

10. A valve according to claim 9, wherein said annular nozzle or said plurality of peripheral nozzles have a variable cross section.

11. A valve according to claim 8, wherein the auxiliary part of the casing comprises an external aspiration jacket, and a channel is defined between the aspiration jacket and the main part of the casing for admission of compressed air into the space defined between the outer surface of the confuser and the internal surface of the casing.

12. A valve according to claim 6, wherein the confuser is a Laval nozzle.

13. A valve according to claim 6, wherein the confuser is formed as a separate part secured inside of the casing with the ability of adjusting its position.

14. A valve according to claim 6, wherein the confuser is integrally formed with the dust and gas mixture flow guiding element.
